(19) United States
(12) Patent Application Publication
(10) Pub. No.: US 2018/0157249 A1
(43) Pub. Date: Jun. 7, 2018

(54) Abnormality Detecting Apparatus

(71) Applicant: Hitachi, Ltd., Chiyoda-ku, Tokyo (JP)

(72) Inventor: Kazuo MUTO, Tokyo (JP)

(21) Appl. No.: 15/579,462

(22) PCT Filed: Jun. 3, 2016
(86) PCT No.: PCT/JP2016/066652

§ 371 Date: Dec. 4, 2017

(30) Foreign Application Priority Data
Jun. 5, 2015 (JP) 2015-115009

(51) Int. Cl. G05B 23/02; G06F 17/16; G06F 19/00; G06F 17/30

(52) U.S. Cl. CPC G05B 23/0235; G06F 17/30607; G06F 19/00; G06F 17/16

(57) ABSTRACT

An abnormality detecting apparatus disclosed herein includes one or more sensors which measure a variety of conditions of a detecting object; a measurement data acquisition unit which acquires measurement data for prediction computation and measurement data for estimation computation from the sensors; a model database which stores a normal behavior model which represents behavior of the detecting object when the object runs normally and a plurality of abnormal behavior models which represent behavior of the detecting object when abnormality occurs therein due to one of various causes; normal behavior model prediction means for calculating predicted values for measurement data for estimation computation in a normal condition of the detecting object from measurement data for prediction computation and a normal behavior model; abnormal behavior model prediction means for calculating predicted values for measurement data for estimation computation in an abnormal condition of the detecting object due to one of various causes from measurement data for prediction computation and a plurality of abnormal behavior models; and abnormality cause estimation means for estimating presence or absence of abnormality of the detecting object and a cause of the abnormality, based on measurement data for estimation computation, predicted values by the normal behavior model prediction means, and predicted values by the abnormal behavior model prediction means.

### TECHNICAL FIELD

The present invention relates to an abnormality detecting apparatus for detecting abnormality of a detecting object, such as a machinery system.

### BACKGROUND ART

In running a machinery system such as a windmill and construction machinery, it is important to shorten downtime during which the machinery system becomes unusable because of maintenance and failure among others. For this reason, in place of time-based maintenance in which maintenance is performed after stopping the run of a machinery system, regardless of whether or not the machinery system is in a healthy condition, condition-based maintenance in which suitable maintenance is performed based on condition of a machinery system is becoming a common practice.

In condition-based maintenance, presence or absence of abnormality is detected from, inter alia, the values of diverse sensors provided in a machinery system and details and a period of a maintenance work are determined. However, in a case where, while presence or absence of abnormality can be detected, a cause of the abnormality is not identifiable, it involved a problem in which it takes some time to find out the cause and downtime cannot be shortened.

To address this problem, an apparatus is proposed that estimates a cause of abnormality from the values of diverse sensors provided in a machinery system and can verify validity of a result of estimating the cause of the abnormality by comparing a result of a simulation using a plant characteristic model correlated to the estimated cause against the values of the sensors (Patent Literature 1).

Also, an apparatus is proposed that constructs a prediction model representing behavior of a machinery system when it runs normally from the values of diverse sensors provided in the machinery system and estimates presence or absence of abnormality and a cause of the abnormality from a tendency of an error between values predicted by the prediction model and the values of the sensors (Patent Literature 2).

### CITATION LIST

### Patent Literature

Patent Literature 1: Japanese Unexamined Patent Application Publication No. Hei 02-129796

### Patent Literature 2: Japanese Unexamined Patent Application Publication No. 2005-149137

### SUMMARY OF INVENTION

### Technical Problem

In a method of Patent Literature 1, a cause of abnormality is estimated using the values of the sensors and validity of the estimated cause of the abnormality is verified according to a simulation using a plant characteristic model correlated to the estimated cause of the abnormality. In this method, when the estimated cause of the abnormality is incorrect, it is needed to estimate a cause of the abnormality again and perform a simulation using a characteristic model correlated to the reestimated cause of the abnormality. In addition, if a plant characteristic model does not represent the plant behavior well, there is a possibility that validity of the estimated cause of abnormality cannot be verified correctly.

In addition, in a method of Patent Literature 2, since a prediction model representing behavior of a machinery system when it runs normally from the values of the sensors, it is impossible to construct an accurate prediction model, unless using the values of the sensors under various operating conditions during a normal run. As a result, even if the system runs in a normal condition, it may be determined to be abnormal.

The present invention has been made in view of circumstances as noted above and is intended to estimate presence or absence of abnormality of a detecting object and its cause.

### Solution to Problem

To solve the above-noted problem, the present invention includes one or more sensors which measure a variety of conditions of a detecting object, a measurement data acquisition unit which acquires measurement data for prediction computation and measurement data for estimation computation from the sensors as measurement data measured by the sensors, a model database which stores a normal behavior model which represents behavior of the detecting object when the object runs normally and a plurality of abnormal behavior models which represent behavior of the detecting object when abnormality occurs therein due to one of various causes, normal behavior model prediction means for calculating predicted values for measurement data for estimation computation in a normal condition of the detecting object from measurement data for prediction computation acquired by the measurement data acquisition unit and a normal behavior model stored in the model database, abnormal behavior model prediction means for calculating predicted values for measurement data for estimation computation in an abnormal condition of the detecting object due to one of various causes from measurement data for prediction computation acquired by the measurement data acquisition unit and a plurality of abnormal behavior models stored in the model database, and abnormality cause estimation means for estimating presence or absence of abnormality of the detecting object and a cause of the abnormality, based on measurement data for estimation computation acquired by the measurement data acquisition means, predicted values by the normal behavior model prediction means, and predicted values by the abnormal behavior model prediction means, and outputs a result of this estimation.

### Advantageous Effects of Invention

According to the present invention, it is possible to estimate presence or absence of abnormality of a detecting object and a cause of the abnormality.

### BRIEF DESCRIPTION OF DRAWINGS

FIG. 1 is a configuration diagram depicting a first example of an abnormality detecting apparatus according to the present invention.

FIG. 2 is a configuration diagram to explain processing by an arithmetic processing unit in a data flow representation.

FIG. 3 is a structural diagram to explain a general structure of a windmill.

FIG. 4 is a configuration diagram of a display screen of estimation result display means.

FIG. 5 is a configuration diagram depicting a second example of an abnormality detecting apparatus according to the present invention.

FIG. 6 is a configuration diagram to explain processing by the arithmetic processing unit in the second example in a data flow representation.

### DESCRIPTION OF EMBODIMENTS

Next, embodiments for implementing the present invention are described in detail while referring to the drawings as appropriate.

### First Example

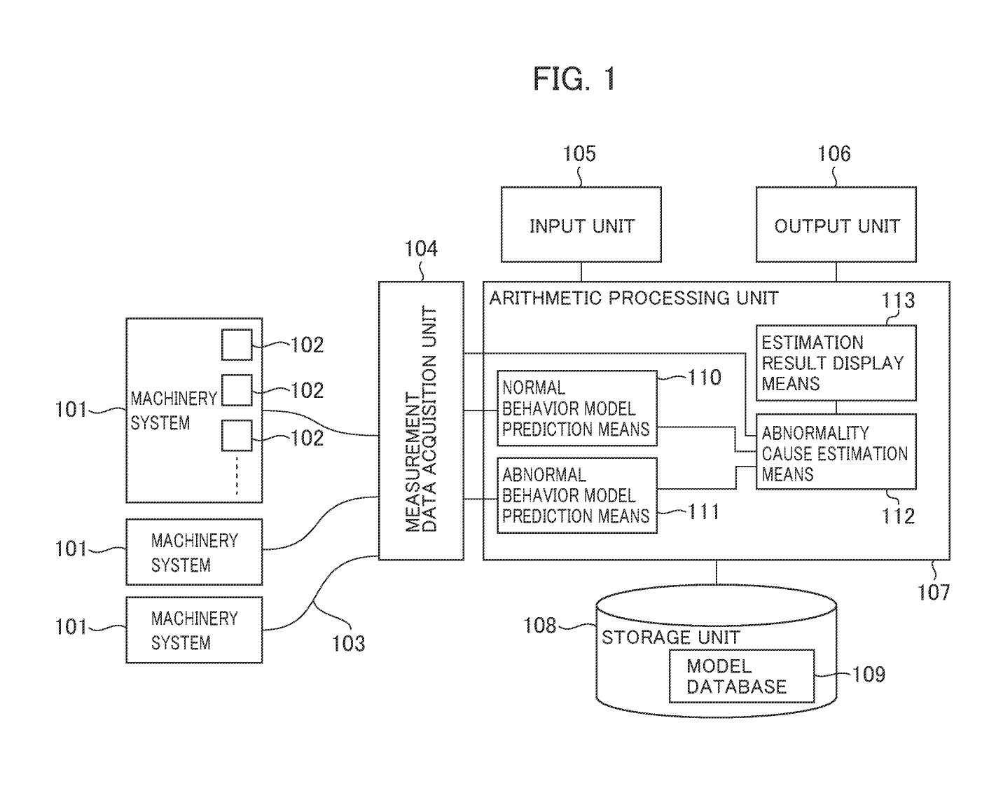

FIG. 1 is a configuration diagram depicting a first example of an abnormality detecting apparatus according to the present invention. In FIG. 1, the abnormality detecting apparatus is comprised of a plurality of machinery systems 101, a plurality of sensors 102 disposed on the respective machinery systems 101, a plurality of communication units 103 which are connected to the respective machinery systems 101, a measurement data acquisition unit 104 which is connected to the respective communication units 103, an input unit 105, an output unit 106, an arithmetic processing unit 107, and a storage unit 108. The measurement data acquisition unit 104, input unit 105, output unit 106, and storage unit 108 are connected to the arithmetic processing unit 107 respectively. Now, the respective units may be interconnected via a network such as Internet or an intranet.

Each machinery system 101 is comprised of, for example, a windmill or construction machinery among others and a plurality of sensors 102 are installed on each machinery system 101. The respective sensors 102 measure diverse conditions of each machinery system 101 which is regarded as a detecting object.

The communication units 103 are communication means such as communication cables, radio, or Internet and transmit measurement data measured by the respective sensors 102 to the measurement data acquisition unit 104.

The measurement data acquisition unit 104 makes analog-to-digital conversion of measurement data transmitted from the respective communication units 103 and is configured as an interface (analog-digital converter) which outputs converted measurement data (digital) to the arithmetic processing unit 107.

The input unit 105 is a set of various input devices such as a keyboard and a mouse and is used when a user inputs any information regarding the present abnormality detecting apparatus.

The output unit 106 is an output device such as a display device and displays a process and a result of processing by the arithmetic processing unit 107 or a screen for interactive processing for a user of the abnormality detecting apparatus.

The arithmetic processing unit 107 is, for example, a computer device including, inter alia, a CPU (Central Processing Unit), a memory, and an input/output interface and executes information processing in the present abnormality detecting apparatus. A plurality of computer programs are stored in the memory. By executing each computer program stored in the memory by the CPU, the arithmetic processing unit 107 functions as normal behavior model prediction means 110, abnormal behavior model prediction means 111, abnormality cause estimation means 112, and estimation result display means 113.

The storage unit 108 is comprised of storage means such as, e.g., a hard disk and, inter alia, a model database 109 is stored in this storage unit 108. In the model database 109, a normal behavior model which represents behavior of a machinery system 101 when it runs normally and an abnormal behavior model which represents behavior of a machinery system 101 when abnormality occurs therein due to one of various causes.

Using a part of measurement data (measurement data for prediction computation) obtained from the measurement data acquisition unit 104 and a normal behavior model stored in the model database 109, the normal behavior model prediction means 110 calculates predicted values for a part of measurement data in a normal condition of a machinery system 101 (the latter part of measurement data is measurement data for estimation computation having a causal relation with the measurement data for prediction computation and measurement data during a run of the machinery system 10).

Using a part of measurement data (measurement data for prediction computation) obtained from the measurement data acquisition unit 104 and a plurality of abnormal behavior models stored in the model database 109, the abnormal behavior model prediction means 111 calculates predicted values for a part of measurement data in an abnormal condition of a machinery system 101 due to one of various causes ((the latter part of measurement data is measurement data for estimation computation having a causal relation with the measurement data for prediction computation).

The abnormality cause estimation means 112 estimates presence or absence of abnormality of a machinery system (a detecting object) 101 and a cause of the abnormality from measurement data (measurement data for estimation computation) that accounts for apart of measurement data obtained from the measurement data acquisition unit 104 and differs from measurement data (measurement data for prediction computation) which is input to the normal behavior model prediction means 110 and the abnormal behavior model prediction means 111 respectively, predicted values by the normal behavior model prediction means 110, and predicted values by the abnormal behavior model prediction means 111.

The estimation result display means 113 displays presence or absence of abnormality of a machinery system (a detecting object) 101 and a cause of the abnormality, estimated by the abnormality cause estimation means 112, on the screen of the output unit 106.

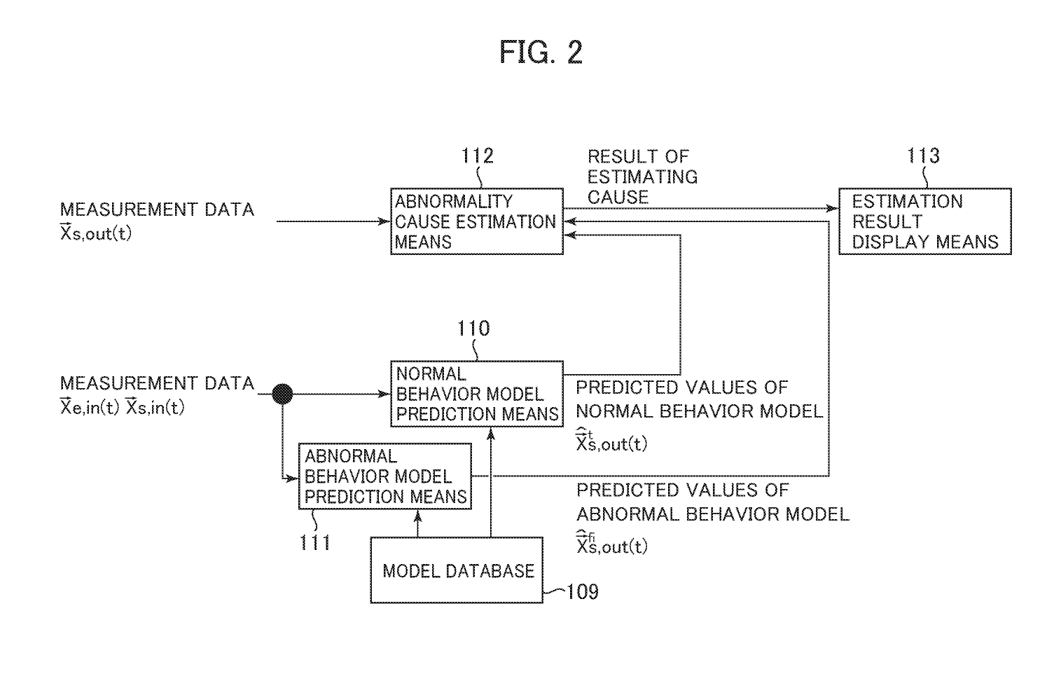

FIG. 2 is a configuration diagram to explain processing by the arithmetic processing unit in a data flow representation. In FIG. 2, using a normal behavior model g^{t}, the normal behavior model prediction means 110 calculates a vector Xₛ^{t}_{,out}(t) of predicted values in a normal condition for a vector X_{s,out}(t) of a part of measurement data (measurement data for estimation computation) which represents a state of a machinery system 101 from a vector X_{e,in}(t) of a part (first measurement data for prediction computation) of measurement data (e.g., wind velocity) which represents an external environment of the machinery system 101 and a vector X_{s,in}(t) of a part (second measurement data for prediction computation) of measurement data (e.g., the rotative force of a windmill and rotor strain) which represents a state of the machinery system 101, accounting for a part of measurement data obtained from measurement data (Equation 1).

[Equation 1]

\vec{\hat{x}}_{s,out}^{t}(t)=g^{t}(θ^{t},\vec{x}_{e,in}(t),\vec{x}_{s,in}(t)) (1)

Here, θ^{t} is a model parameter. A normal behavior model may be derived from a physical correlation between a vector X_{e,in} (t) and a vector X_{s,in} (t) a vector X_{s,out} (t). In addition, a normal run of a machinery system 101 may be simulated, and with values of vectors X_{e,in} (t)ᵣ X_{s,in} (t), and X_{s,out} (t) calculated and from results of these calculations, a normal behavior model may be constructed using a system identification technique or the like (Non-Patent Literature 1: “Seigyo no Tame no Jokyu System Dotei”, Shuichi Adachi, Tokyo Denki University Press”).

On the other hand, using an abnormal behavior model gᵢ^{f}, the abnormal model prediction means 112 calculates a vector Xₛ^{fi}_{,out} (t) of predicted values in an abnormal condition due to one of various causes for a vector X_{s,out} (t) of a part of measurement data (measurement data for estimation computation) which represents a state of a machinery system 101 from a vector X_{e,in} (t) of a part (first measurement data for prediction computation) of measurement data which represents an external environment of the machinery system 101 and a vector X_{s,in} (t) of a part (second measurement data for prediction computation) of measurement data which represents a state of the machinery system 101, accounting for a part of measurement data obtained from measurement data (Equation 2).

[Equation 2]

\vec{\hat{x}}_{s,out}^{fi}(t)=gᵢ^{t}(θᵢ^{t},\vec{x}_{e,in}(t),\vec{x}_{s,in}(t)) (2)

Here, a suffix ᵢ denotes an abnormal behavior model corresponding to an ᵢ-th cause. Also, θᵢ^{f} is a model parameter. An abnormal behavior model is created for each of possible causes of abnormality that are presumed. An abnormal behavior model may be derived from a physical correlation between a vector X_{e,in} (t) and a vector X_{s,in} (t), a vector X_{s,out} (t) when abnormality occurs. A run of a machinery system 101 with abnormality occurring may be simulated, and with values of vectors X_{e,in}(t), X_{s,in}(t) and X_{s,out}(t) calculated and from results of these calculations, an abnormal behavior model may be constructed using a system identification technique or the like (Non-Patent Literature 1).

Next, the abnormality cause estimation means 112 estimates presence or absence of abnormality and what is a cause of the abnormality, if present, by using a vector X_{s,out} (t) of a part of measurement data (measurement data for estimation computation) which represents a state of a machinery system 101 and a vector Xₛ^{t}_{,out} (t) of predicted values of a normal behavior model and a vector Xₛ^{fi}_{,out} (t) of predicted values of an abnormal behavior model associated with the part of measurement data. For example, a model that gives predicted values that are closest to the vector X_{s,out} (t) of the measurement data for estimation computation is regarded as a model that represents a current state of the machinery system 101. If that model is a normal behavior model, the machinery system 101 is determined to be in a normal condition. If that model is an abnormal behavior model, the machinery system 101 is determined to be in an abnormal condition and its cause is regarded as an abnormal cause corresponding to the abnormal behavior model.

Then, the estimation result display means 113 displays at least presence or absence of abnormality of the machinery system 101 and a cause of the abnormality, if present, estimated by the abnormality cause estimation means 112. This enables the user of the present abnormality detecting apparatus to know presence or absence of abnormality of the machinery system 101 and a cause of the abnormality, if present.

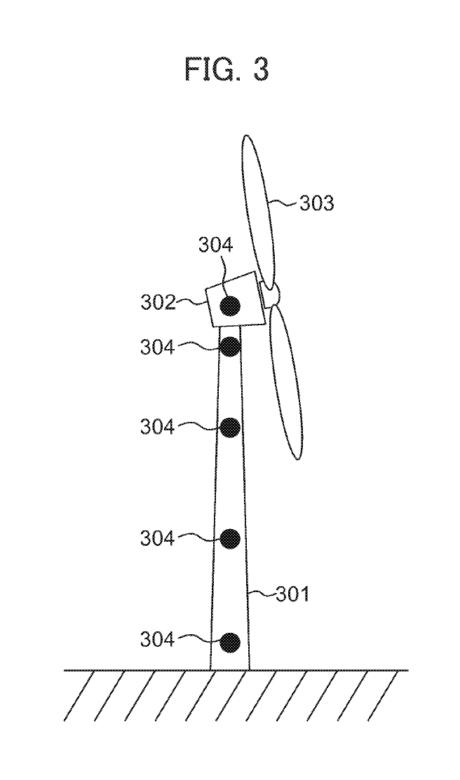

FIG. 3 is a structural diagram to explain a general structure of a windmill. In FIG. 3, as one example of a machinery system 101, the windmill is comprised of a tower 301, a nacelle 302 fixed to the head of the tower 301, a rotor 303 rotatably fixed to the nacelle 302. In segments of the tower 301 and the nacelle 302, sensors 304 capable of detecting displacement in each segment, such as an acceleration sensor and a GPS (Global Positioning System), are installed. Here, from measurement values (measurement data for prediction computation) of k sensors out of n sensors 304 installed on the windmill, measurement values (measurement data for estimation computation) of the remaining n-k sensors are predicted. Determination is made of whether the predicted values most match with a normal model or any abnormal model and a condition of the windmill is detected. Now, although data representing an external environment of the windmill is not used in this application case, it is also possible to use data representing an external environment of the windmill (e.g., wind velocity and wave height). A processing flow is described below.

When per-segment displacement data that can be acquired from the sensors 304 is assumed as vector X₁(t), vector X₂(t), . . . , vector Xₙ(t) first, using a normal behavior model g^{t}, the normal behavior model prediction means 110 calculates, from a part (measurement data for prediction computation) of this data, namely, vector X₁(t), vector X₂(t), . . . , vector Xₖ(t) predicted values, vector Xₖ₊₁^{t}(t), vector Xₖ₊₂^{t}(t), . . . , vector Xₙ^{t}(t) for the remaining data (measurement data for estimation computation), namely, vector Xₖ₊₁(t), vector X₂(t), . . . , vector Xₙ(t), assuming that the windmill operates normally (Equation 3).

[Equation 3]

[\vec{\hat{x}}ₖ₊₁^{t}(t),\vec{\hat{x}}ₖ₊₂^{t}(t), . . . ,\vec{\hat{x}}ₙ^{t}(t)]^{T}=g^{t}(θ^{t},\vec{x}₁(t),\vec{x}₂(t), . . . ,\vec{x}ₖ(t)) (3)

Here, θ^{t} is a model parameter. A normal behavior model g^{t} is obtained by modeling the tower 301, nacelle 302, and rotor (blades) 303 of the windmill with joist elements based on, e.g., a finite element method and deriving a dynamic relational expression between vector X₁(t) vector X₂(t), . . . , vector Xₖ(t) and vector Xₖ₊₁(t), vector X₂(t), . . . , vector Xₙ(t) (Non-Patent Literature 2: “A NUMERICAL STUDY ON DYNAMIC RESPONSE OF SEMI-SUBMERSIBLE FLOATING OFFSHORE WIND TURBINE SYSTEM AND ITS VERIFICATION BY EXPERIMENT”, Pham Van Phuc and Takesi Ishihara, Journal of Japan Society of Civil Engineers A, Vol. 65, No 3, 601-607, 2009, 7).

Meanwhile, using an abnormal behavior model gᵢ^{f}, the abnormal behavior model prediction means 111 calculates, from a part (measurement data for prediction computation) of the data, namely, vector X₁(t), vector X₂(t), . . . , vector Xₖ(t) out of per-segment displacement data vector X₁(t), vector X₂(t), . . . , vector Xₙ(t) that can be acquired from the sensors 304, predicted values, vector Xₖ₊ₗ^{fi} (t vector Xₖ₊₂^{fi} (t), . . . , vector Xₙ^{fi} (t) for the remaining data (measurement data for estimation computation), namely, vector Xₖ₊₁ (t), vector X₂(t), . . . , vector Xₙ(t), assuming that the windmill malfunctions due to a cause (Equation 4).

[Equation 4]

[\vec{\hat{x}}ₖ₊₁^{fi}(t),\vec{\hat{x}}ₖ₊₂^{fi}(t), . . . ,\vec{\hat{x}}ₙ^{fi}(t)]^{T}=g₁^{f}(θᵢ^{f},\vec{x}₁(t),\vec{x}₂(t), . . . ,\vec{x}ₖ(t)) (4)

Here, θᵢ^{f} is a model parameter. As an abnormal behavior model, for example, a model g₁^{f} which represents the windmill behavior when a gearbox of a generator stored in the windmill nacelle has been broken, a model g₂^{f} which represents the windmill behavior when a bolt or the like in the connection of the tower 301 has been broken or loosened, and so on should be prepared in advance. Now, an abnormal behavior model gᵢ^{f} is also obtained by modeling the tower 301, nacelle 302, and rotor (blades) 303 of the windmill with joist elements based on, e.g., a finite element method for a state in which a gearbox has been broken and a state in which a bolt in the connection of the tower 301 has been broken or loosened and deriving a dynamic relational expression between vector X₁(t), vector X₂(t), . . . , vector Xₖ(t) and vector Xₖ₊₁(t), vector X₂(t), . . . , vector Xₙ(t) (Non-Patent Literature 2).

Then, the abnormality cause estimation means 112 estimates presence or absence of abnormality of the machinery system 101 and a case of the abnormality by comparing the predicted values, vector Xₖ₊ₗ^{t}(t), vector Xₖ₊₂^{t}(t), . . . , vector Xₙ^{t}(t) of a normal behavior model, the predicted values, vector Xₖ₊₁^{f1}(t), vector Xₖ₊₂^{f1} (t), . . . , vector Xₙ^{f1} (t) of an abnormal behavior model g₁^{f}, and the predicted values, vector Xₖ₊₁^{f2}(t), vector Xₖ₊₂^{f2}(t), . . . , vector Xₙ^{f2}(t) of an abnormal behavior model g₂^{f} against the values of vector Xₖ₊₁(t), vector Xₖ₊₂(t), . . . , vector Xₙ(t) measured by the sensors 304. For example, calculations are made of integral values e^{t} (t_{c}), e₁^{f} (t_{c}), and e₂^{f} (t_{c}) of differences between vector Xₖ₊₁(t), vector Xₖ₊₂(t), . . . , vector Xₙ(t) and vector Xₖ₊₁^{t}(t), vector Xₖ₊₂^{t}(t), . . . , vector Xₙ^{t}(t), between vector Xₖ₊₁ (t) vector Xₖ₊₂(t), . . . , vector Xₙ(t) and vector Xₖ₊₁^{f1}(t), Xₖ₊₂^{f1}(t), . . . , vector Xₙ^{f1}(t), and between vector Xₖ₊₁(t), vector Xₖ₊₂(t), . . . , vector Xₙ(t) and vector Xₖ₊₁^{f2}(t), vector Xₖ₊₂^{f2}(t), . . . , vector Xₙ^{f2}(t) for a period from time t_{c}−T to time t_{c}, using Equations 5 through 7 below.

[Equation 5]

e^{t}(t_{c})=∫ₜ_{_{c}}_{-T}^{t}^{_{c}}|\vec{X}(t)−\vec{X}ⁱ(t)|²dt (5)

[Equation 6]

e₁^{f}(t_{c})=∫ₜ_{_{c}}_{-T}^{t}^{_{c}}|\vec{X}(t)−\vec{X}₁^{f}(t)|²dt (6)

[Equation 7]

e₂^{f}(t_{c})=∫ₜ_{_{c}}_{-T}^{t}^{_{c}}|\vec{X}(t)−\vec{X}₂^{f}(t)|²dt (7)

where,

[Equation 8]

\vec{X}(t)=[\vec{x}ₖ₊₁(t),\vec{x}ₖ₊₂(t), . . . ,\vec{x}ₙ(t)]^{T}. (8)

[Equation 9]

\vec{X}^{t}(t)=[\vec{\hat{x}}ₖ₊₁^{t}(t),\vec{\hat{x}}ₖ₊₂^{t}(t), . . . ,\vec{\hat{x}}ₙ^{t}(t)]^{T} (9)

[Equation 10]

\vec{X}₁^{f}(t)=[\vec{\hat{x}}ₖ₊₁^{f1}(t),\vec{\hat{x}}ₖ₊₂^{f1}(t), . . . ,\vec{\hat{x}}ₙ^{f1}(t)]^{T} (10)

[Equation 11]

\vec{X}₂^{f}(t)=[\vec{\hat{x}}ₖ₊₁^{f2}(t),\vec{\hat{x}}ₖ₊₂^{f2}(t), . . . ,\vec{\hat{x}}ₙ^{f2}(t)]^{T} (11)

In addition, vector size represents a norm of a vector X. At this time, if an integral value eₜ (t_{c}) is smallest, the windmill is determined to be in a normal condition. On the other hand, if an integral value e₁^{f} (t_{c}) is smallest, it is estimated that the windmill is in an abnormal condition and the reason is failure of a gearbox. In addition, if an integral value e₂^{f}(t_{c}) is smallest, it is estimated that the windmill is in an abnormal condition and the reason is that a bolt or the like in the connection of the tower is broken or loosed.

Then, the estimation result display means 113 displays presence or absence of abnormality of the windmill and a cause of the abnormality, if present, estimated by the abnormality cause estimation means 112, on the screen of the output unit 106.

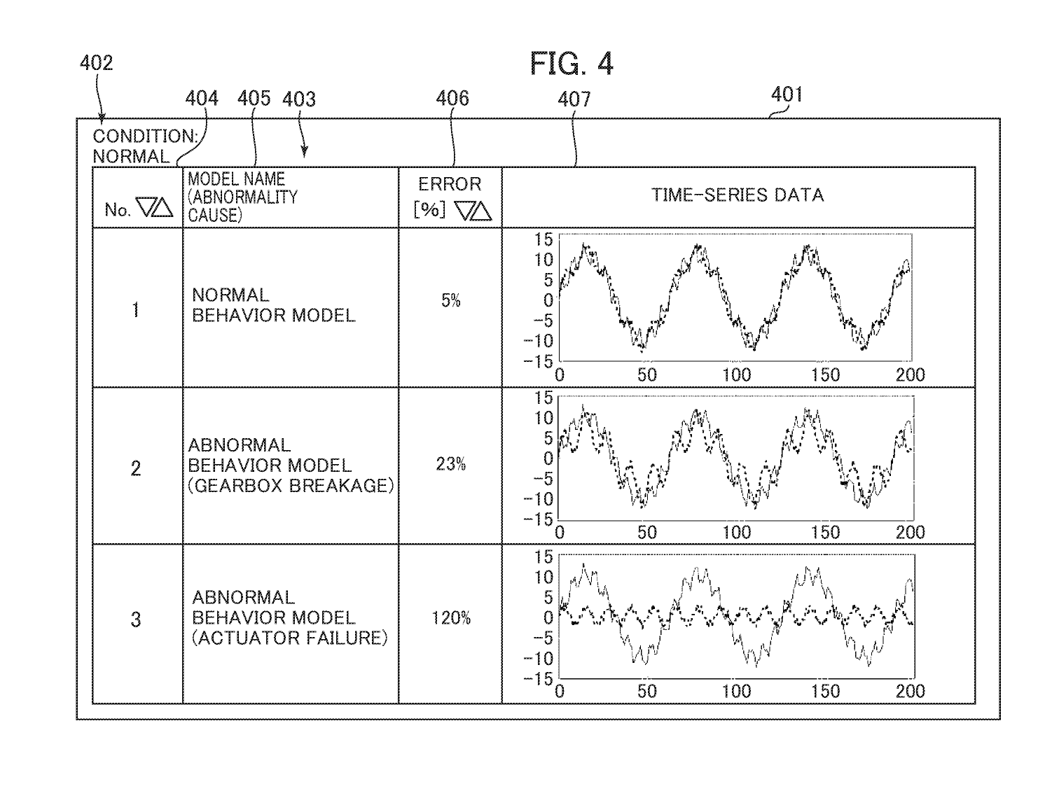

FIG. 4 is a configuration diagram of a display screen of the estimation result display means. In FIG. 4, the display screen 401 of the estimation result display means 113 is comprised of a condition display area 402 and a model display area 403. In the condition display area 402, for example, presence or absence of abnormality of the windmill is displayed as presence or absence of abnormality of a detecting object. At this time, if the windmill is normal, “normal” is displayed; if the windmill is abnormal, “abnormal” is displayed.

The model display area 403 is comprised of fields of No. 404, model name 405, error 406, and time-series data 407. In a No. 404 field, the number of a normal behavior model or an abnormal behavior model used for detecting abnormality of the windmill is displayed. In a model name 405 field, the name of a normal behavior model or an abnormal behavior model used for detecting abnormality of the windmill is displayed. When the name of an abnormal behavior model is displayed in the model name 405 field, information of a cause of abnormality of the windmill is also displayed. In an error 406 field, an error between measurement data (measurement data for estimation computation) and predicted values of each model (predicted values by the normal behavior model prediction means 110 or predicted values of the abnormal behavior model prediction means 111) is displayed. At this time, if the error of the normal behavior model is the smallest among the errors of all the models, “normal” is displayed in the condition display area 402. Meanwhile, if the error of an abnormal behavior model among all the models, for instance, if the error of abnormal behavior model No. 2 (the model used as an abnormal behavior model in the case of gearbox breakage) is the smallest, “abnormal” is displayed in the condition display area 402. In this case, “gearbox breakage” is displayed as a cause of the abnormality in the model name 405 field. In a time-series data 407 field, time-series data of predicted values of a normal behavior model or an abnormal behavior model used for detecting abnormality of the windmill and measurement data (measurement data for estimation computation) is displayed.

According to the present example, it is possible to estimate not only presence or absence of abnormality of a machinery system 101 or a windmill which is a detecting object, but also a cause of the abnormality at the same time. Consequently, maintenance of the machinery system 101 or the windmill can be performed without taking time to find out the cause and downtime of the machinery system 101 or the windmill can be shortened.

### Second Embodiment

In the present example, an example of an abnormality detecting apparatus is described that adjusts model parameters of a normal behavior model and an abnormal behavior model in concurrence with estimating presence or absence of abnormality of a detecting object and a cause of the abnormality using a normal behavior model and an abnormal behavior model. Thereby, it is possible to estimate presence or absence of abnormality of a detecting object and a cause of the abnormality at higher accuracy.

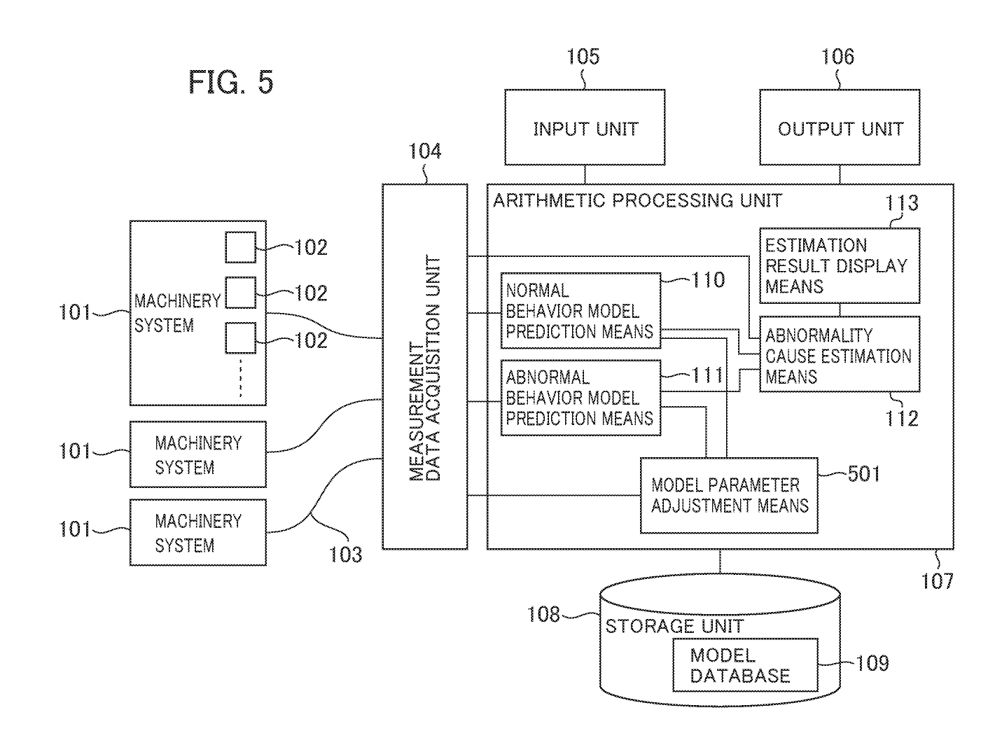

FIG. 5 is a configuration diagram depicting a second example of an abnormality detecting apparatus according to the present invention. Now, the abnormality detecting apparatus in the present example is the one in which a model parameter adjustment means 501 is added to the arithmetic processing unit 107 and other components are the same as those in the first example; as for components assigned the same reference numerals as in the first example and parts having the same functions as in the first example, their description is omitted.

The arithmetic processing unit 107 is comprised of the normal behavior model prediction means 110, abnormal behavior model prediction means 111, abnormality cause estimation means 112, estimation result display means 113, and model parameter adjustment means 501. Again, by executing each computer program stored in the memory by the CPU, the arithmetic processing unit 107 functions as the normal behavior model prediction means 110, abnormal behavior model prediction means 111, abnormality cause estimation means 112, estimation result display means 113, and model parameter adjustment means 501.

The model parameter adjustment means 501 adjusts model parameters of a normal behavior model and an abnormal behavior model based on measurement data and improves the accuracy of estimation with a normal behavior model and an abnormal behavior model. For example, the model parameter adjustment means 501 adjusts model parameters of a normal behavior model which is used by the normal behavior model prediction means 110 so as to minimize differences between measurement data (measurement data for prediction computation and measurement data for estimation computation) acquired by the measurement data acquisition unit 104 and predicted values by the normal behavior model prediction means 110 and adjusts model parameters of an abnormal behavior model which is used by the abnormal behavior model prediction means 111 so as to minimize differences between measurement data (measurement data for prediction computation and measurement data for estimation computation) acquired by the measurement data acquisition unit 104 and predicted values by the abnormal behavior model prediction means 111.

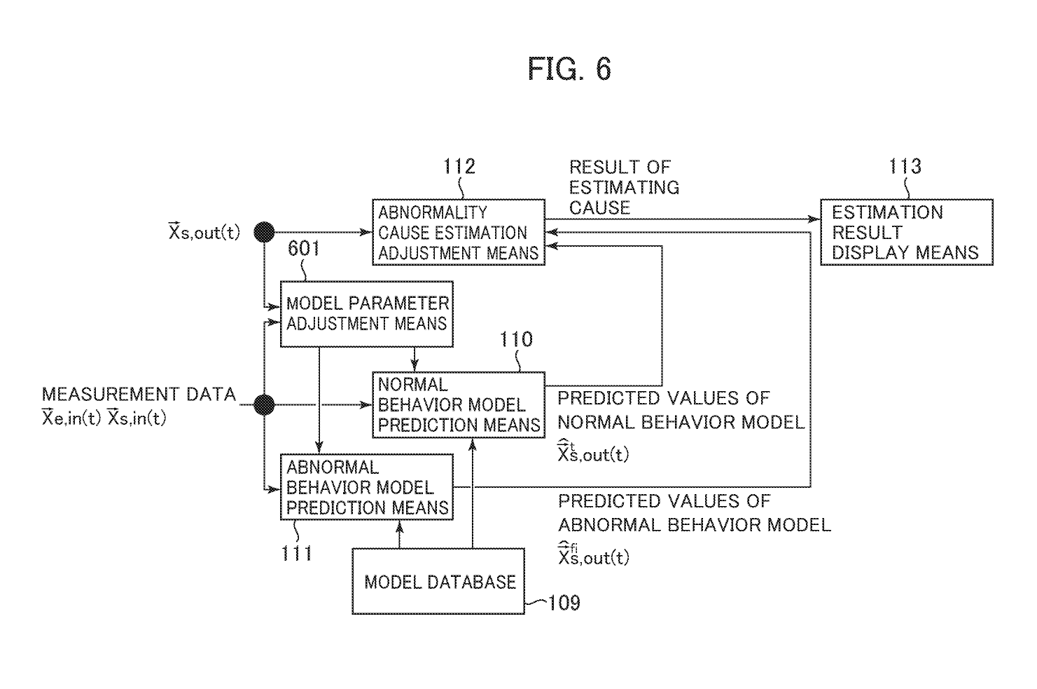

FIG. 6 is a configuration diagram to explain processing by the arithmetic processing unit in the second example in a data flow representation. Now, in the present example, as for components assigned the same reference numerals and parts having the same functions as in the first example, their description is omitted.

The model parameter adjustment means 501 adjusts model parameters θ^{t} of a normal behavior model and model parameters θᵢ^{f} of an abnormal behavior model, based on measurement data acquired by the measurement data acquisition unit 104. Specifically, an adjustment is made of model parameters of a normal behavior model or an abnormal behavior model for which an integral value of differences against measurement data for a period from time t_{c}−T to time t_{c} is determined to be the smallest by the abnormality cause estimation means 112 so as to minimize differences between the predicted values of the normal behavior model or the predicted values of the abnormal behavior model and the measurement data.

In this regard, according to the type of a normal behavior model or an abnormal behavior model, model parameters are modified using a method, such as an iterative least squares technique (Non-Patent Literature 1) and an ensemble Kalman filter (Non-Patent Literature 3: “beta Doka Nyumon”, Tomoyuki Higuchi, Asakura Publishing). For example, in the case of the windmill depicted in FIG. 3, an adjustment is made of parameters, such as a Young's modulus and an attenuation coefficient for the members of the tower 301, of a normal behavior model or an abnormal behavior model which is represented in a finite element model.

According to the present example, model parameters of a normal behavior model are adjusted so as to minimize differences between measurement data and predicted values by the normal behavior model prediction means 110 and model parameters of an abnormal behavior model are adjusted so as to minimize differences between measurement data and predicted values by the abnormal behavior model prediction means 111; thus, it is possible to estimate presence or absence of abnormality of a detecting object and a cause of the abnormality with higher accuracy.

The present invention is not limited to the described examples and various modifications are included therein. For example, the output unit 106 and the estimation result display means 113 can be combined into an integral unit. The foregoing examples are those described in detail to explain the present invention clearly and the present invention is not necessarily limited to those including all components described. In addition, a subset of the components of an example can be replaced by components of another example. Also, to the components of one example, components of another example can be added. Also, for a subset of the components of each example, other components can be added to the subset or the subset can be removed or replaced by other components.

In addition, a subset or all of the aforementioned components, functions, etc. may be implemented by hardware; for example, by designing an integrated circuit to implement them. In addition, the aforementioned components, functions, etc. may be implemented by software in such away that a processor interprets and executes a program that implements the respective functions. Information such as a program implementing the respective functions, tables, and files can be placed in a recording device such as a memory, hard disk, and SSD (Solid State Drive) or a recording medium such as an IC (Integrated Circuit) card, SD (Secure Digital) card, and DVD (Digital Versatile Disc).

### LIST OF REFERENCE SIGNS

101 Machinery system,
102 Sensor,
103 Communication unit,
104 Measurement data acquisition unit,
105 Input unit,
106 Output unit,
107 Arithmetic processing unit,
108 Storage unit,
109 Model database,
110 Normal behavior model prediction means,
111 Abnormal behavior model prediction means,
112 Abnormality cause estimation means,
113 Estimation result display means,
501 Model parameter adjustment means.

1. An abnormality detecting apparatus comprising:
one or more sensors which measure a variety of conditions of a detecting object;
a measurement data acquisition unit which acquires measurement data for prediction computation and measurement data for estimation computation from the sensors as measurement data measured by the sensors;
a model database which stores a normal behavior model which represents behavior of the detecting object when the object runs normally and a plurality of abnormal behavior models which represent behavior of the detecting object when abnormality occurs therein due to one of various causes;
normal behavior model prediction means for calculating predicted values for measurement data for estimation computation in a normal condition of the detecting object from measurement data for prediction computation acquired by the measurement data acquisition unit and a normal behavior model stored in the model database;
abnormal behavior model prediction means for calculating predicted values for measurement data for estimation computation in an abnormal condition of the detecting object due to one of various causes from measurement data for prediction computation acquired by the measurement data acquisition unit and a plurality of abnormal behavior models stored in the model database; and
abnormality cause estimation means for estimating presence or absence of abnormality of the detecting object and a cause of the abnormality, based on measurement data for estimation computation acquired by the measurement data acquisition means, predicted values by the normal behavior model prediction means, and predicted values by the abnormal behavior model prediction means, and outputs a result of this estimation.

2. The abnormality detecting apparatus according to claim 1, comprising estimation result display means for displaying a result of estimation by the abnormality cause estimation means.

3. The abnormality detecting apparatus according to claim 1, comprising model parameter adjustment means for adjusting model parameters of the normal behavior model which is used by the normal behavior model prediction means so as to minimize differences between measurement data for prediction computation as well as measurement data for estimation computation acquired by the measurement data acquisition means and predicted values by the normal behavior model prediction means and adjusting model parameters of each of the abnormal behavior models which is used by the abnormal behavior model prediction means so as to minimize differences between measurement data for prediction computation as well as measurement data for estimation computation acquired by the measurement data acquisition means and predicted values by the abnormal behavior model prediction means.

4. The abnormality detecting apparatus according to claim 1,
wherein measurement data for prediction computation acquired by the measurement data acquisition means is measurement data representing an external environment of the detecting object and measurement data representing a state of the detecting object; and
measurement data for estimation computation acquired by the measurement data acquisition means is measurement data that accounts for a part of the measurement data for prediction computation and has a causal relation with measurement data representing a state of the detecting object.

5. The abnormality detecting apparatus according to claim 1,
wherein in comparing differences between measurement data for estimation computation acquired by the measurement data acquisition means and predicted values by the normal behavior model prediction means and differences between the measurement data for estimation computation and predicted values by the abnormal behavior model prediction means, if the differences between the measurement data for estimation computation and the predicted values by the abnormal behavior model prediction means are smallest, the abnormality cause estimation means estimates a cause of abnormality of the detecting object from an abnormal behavior model used in calculating predicted values by the abnormal behavior model prediction means.
